(19) United States
(12) Patent Application Publication
(10) Pub. No.: US 2006/0191392 A1
(43) Pub. Date: Aug. 31, 2006

(54) FLAT MEDIA CUTTING DEVICE

(76) Inventor: Tzu-Feng Tseng, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/382,064

(22) Filed: May 8, 2006

Related U.S. Application Data
(62) Division of application No. 10/709,570, filed on May 14, 2004.

(51) Int. Cl. B26D 1/18

(52) U.S. Cl. 83/455; 83/614; 83/578

(57) ABSTRACT

A flat media cutting device includes a planar base, two supports fixed to the base, a clamp extending between the two supports, a slider mounted in a slidable manner on the clamp, a linear actuator parallel to the clamp and connected to the slider, and a motor connected to the linear actuator. Each end of the clamp is connected to one support. At least one support prevents movement of the clamp in the second direction and opposite, and both supports allow movement of the clamp in the first direction and opposite. When the motor drives the linear actuator, the slider is driven along the clamp and a cutting tool of the slider cuts media held to the base by the clamp.

### CROSS REFERENCE TO RELATED APPLICATIONS

This is a division of application Ser. No. 10/709,570, filed May 14, 2004.

### BACKGROUND OF THE INVENTION

1. Field of the Invention

The present invention relates to cutting machine, and more specifically, to a cutting machine for cutting flat media such as paper.

2. Description of the Prior Art

Small manually operated machines, commonly known as “paper cutters” are well known to anyone who has worked in an office.

Paper cutters are typically used for cutting things such as paper and transparencies, and come in a wide variety of designs. The most well known type of paper cutter has a flat base and a hinged blade. A user positions the media to be cut so that it overhangs the base, and then brings the hinged blade down so that the media is cut along the path of the blade. A striking problem with this type of cutter is that a large blade (usually 12″-30 cm) is exposed during operation, creating an injury hazard. Other types of paper cutters have been developed to improve upon the hinged-blade variety, however, these typically require manual actuation of the cutting tool.

With the proliferation of personal computers and printers, paper cutting is now something no longer regulated to specialized office personnel. Home and small business users are increasingly undertaking their own paper cutting tasks. As such, a paper cutter having improved safety and ease-of-use is required.

### SUMMARY OF THE INVENTION

It is therefore a primary objective of the claimed invention to provide a flat media cutting device to solve the above-mentioned problems.

Briefly summarized, the claimed invention includes a planar base, two supports fixed to the base, a clamp extending between the two supports, a slider mounted in a slidable manner on the clamp, a linear actuator parallel to the clamp and connected to the slider, and a motor connected to the linear actuator. Each end of the clamp is connected to one support. At least one support prevents movement of the clamp in the second direction and opposite, and both supports allow movement of the clamp in the first direction and opposite. When the motor drives the linear actuator, the slider is driven along the clamp and a cutting tool of the slider cuts media held to the base by the clamp.

It is an advantage of the claimed invention that the cutting tool is moved automatically by a motor.

It is an advantage of the claimed invention that the slider allows the cutting tool to be small and thus safe.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view of a flat media cutting device according to the present invention.

FIG. 2 is an exploded perspective of the supports and clamp of FIG. 1.

FIG. 3 is a perspective view of the slider of FIG. 1.

FIG. 4 is a cross-sectional view of the gear transmission of FIG. 1.

FIG. 5 is a cross-sectional view of flexible-connector transmission according to the present invention.

FIG. 6 is a cross-sectional view of belt transmission according to the present invention.

FIG. 7 is a front view of another embodiment of the linear actuator and slider of FIG. 1.

FIG. 8 is a front view of a belt-type linear actuator according to the present invention.

### DETAILED DESCRIPTION

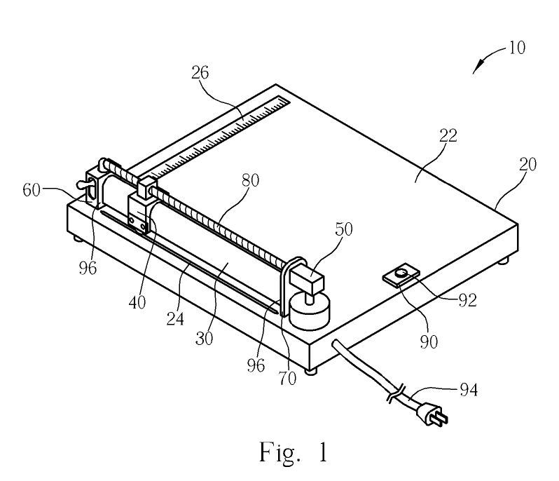

FIG. 1 illustrates a perspective view of a flat media cutting device 10 according to the present invention. The cutting device 10 comprises a planar base 20, two supports 60, 70 fixed to the base, a clamp 30 positioned between the two supports 60, 70, a slider 40 mounted on the clamp 30, a linear actuator 80 (threaded rod) running parallel to the clamp 30 and connected to the slider 40, a motor assembly 50 for driving the linear actuator 80, and an electrical system 90 for powering the motor. The motor assembly 50 draws power from the electrical system 90 to drive the linear actuator 80 to move the slider 40 along the clamp 30 to cut flat media held firmly to the base 20 by the clamp 30.

The planar base 20 includes a flat board or plate 22 on which to place flat media, such as paper, plastic transparencies, textiles, thin metal, or similar. The plate 22 includes a groove 24 to accommodate the cutting tool of the slider 40. The design of the groove 24 depends on the cutting tool, and it can be omitted. A scale 26 is located on the plate 22 in a position so that media to be cut can be easily measured. The scale 26 can have any desired measurements (inches, cm, mm, etc) and can include a ridge (not shown) to properly align the media to be cut. The plate 22 can be made of plastic, metal, or wood, with plastic currently being the most versatile and economic choice.

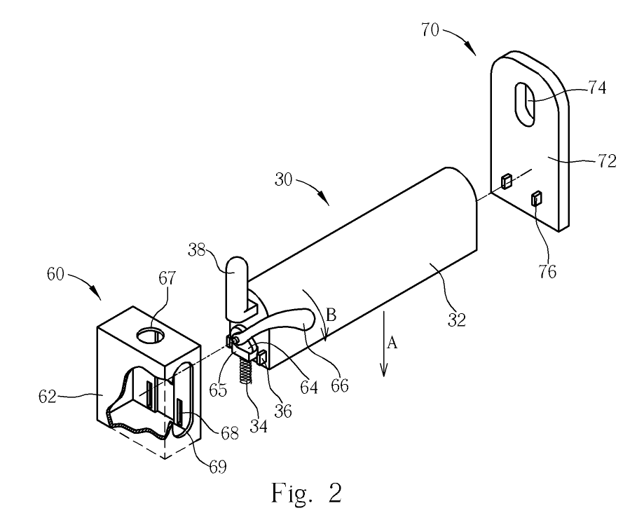

Referring to the exploded view of FIG. 2, the supports 60, 70 and the clamp 30 are shown in detail. The support 60 includes a support body 62 having one end open (hidden line), two openings 67, 69, and a pair of slots 68. The support 70 includes a support body 72, a slot 74, and a pair of pins 76. The clamp 30 includes a clamp body 32 having a protrusion 34, a pair of pins 36, and a post 38 extending from one end. The slot 74 accommodates the linear actuator 80, allowing it to move in the A direction with the clamp 30. The pins 76 mate with slots (not shown) on the other end of the clamp body 32, and serve the same purpose of the pins 36 and slots 68. The support bodies 62, 72, pins 36, 76, and slots 68 prevent movement of the clamp 30 in all directions except the A direction (first direction) and opposite, the reversed arrangement of pins and slots on opposite ends of the clamp body merely being to illustrate various design possibilities. The open end of the support body 62 faces the same end of the clamp body 32 so that the pins 36 fit into the slots 68 and the post 38, which holds the linear actuator 80, fits into the opening 67 (see FIG. 1). Further provided are a cam 64, a spring 65, and a handle 66 that make up a clamp actuator. The cam 64 and handle 66 are fixed together and pivotally connected to the inside of the support body 62, the handle 66 extending from the opening 69. The spring 65 is connected between the protrusion 34 and the inside of the support body 62, and tends to push upwards on the protrusion 34. When the handle 66 is moved in the B direction the cam 64 acts against the protrusion 34 to move the clamp 30 in the A direction, the pins 36 guiding the clamp 30 by way of the slots 68. When the handle 66 is moved opposite the B direction, the spring 34 pushes the clamp 30 in opposite the A direction. In this way, the clamp 30 can be moved and locked to hold media to the base 20. The supports 60, 70 can be similar or identical to each other, with the specific designs disclosed here being examples. The clamp actuator (cam 64, spring 65, handle 66) can vary from the specific example shown, and two clamp actuators can be provided at each end of the clamp 30. Furthermore, the clamp 30 could be pivoted at the support 70 end so that movement of the clamp 30 in the A direction and opposite increases towards the support 60. The supports 60, 70 can be made of metal or plastic, and can be permanently fixed to the base, or removable by screw or clips. The clamp 30 can be made of metal (i.e. aluminum) or plastic, with metal providing a more rigid structure.

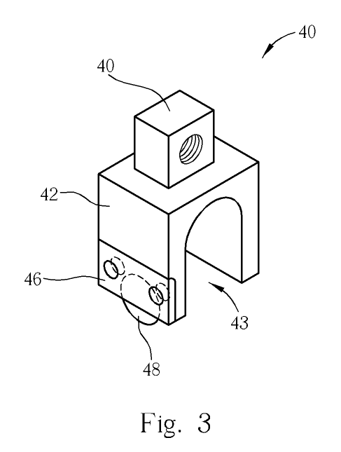

FIG. 3 illustrates a close up view of the slider 40. The slider 40 comprises a slider body 42 having an opening 43, a connector 44 attached to the slider body 42 and having a threaded hole for mating with the linear actuator (threaded rod) 80, a panel 46 removable from the slider body 42, and a cutting tool (i.e. a rotating round blade) 48 protected by the removable panel 46. Other types of cutting tools can also be used, such as a fixed straight blade or a rotating blade for making a non-straight cuts. The slider 40 fits onto the clamp 30 by the opening 43 straddling the clamp body 32 (see FIG. 1). While the opening 43 is illustrated as an arch, any shape is permissible provided that the slider 40 adequately matches the shape of the clamp 30. When the threaded rod 80 is turned, the slider 40 is driven along the clamp 30 via the connector 44 so that the cutting tool 48 is drawn across the media. When the cutting tool 44 needs to be replaced or adjusted (i.e. in height), a user merely has to remove the panel 46 and make and changes desired. The slider 40 can be of plastic or metal, with metal being a good choice for the threaded hole of the connector 44 and the cutting tool 48.

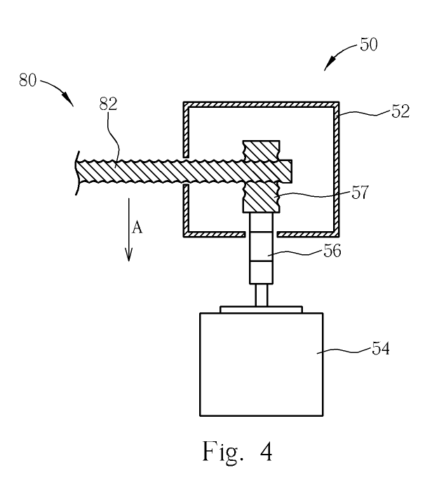

As mentioned, in a preferred embodiment the linear actuator 80 is a threaded rod. FIG. 2 illustrates the post 38 for rotatably holding one end of the threaded rod 80. FIG. 3 illustrates the threaded connector 44 that mates with the threaded rod 80 for driving the slider 40. FIG. 4 shows the threaded rod 80 in detail. It should be noted that a threaded rod is just one embodiment of the linear actuator, and other embodiments will be discussed in detail later.

Please refer to FIG. 4, illustrating a cross-sectional view of the threaded rod 80 and the motor assembly 50. The motor assembly 50 includes a transmission box 52, an electric motor 54, a friction clutch 56, and a gear 57 to mesh with the a thread 82 of the threaded rod 80. The box 52 can be fixed to the base 20 or the support 70 (see FIG. 1) and has openings to accommodate the threaded rod 80 and the shaft of the motor 54. The friction clutch 56 is a mechanical clutch that simply limits the torque that the motor 54 is allowed to provide to the gear 57, so that if the drive line (gear 57 to cutting tool 44) becomes jammed the motor 54 can still rotate. This prevents damage to the drive line and reduces potential for injury to a user. The friction clutch 56 is well-known and can include devices such as a hollow-cylinder and pin assembly. The gear 57 is long enough so that when the threaded rod 80 moves in the A direction with the clamp 30, the thread 82 can still mesh with the gear 57 so that the threaded rod 80 can still be driven. It should be noted that since the threaded rod 80 may not be desired to be driven when the clamp 30 is released, so the gear 57 can be shortened such that it does not mesh with the thread 82 until the threaded rod 80 is moved in the A direction. As a result, the motor 54 can transmit mechanical power to the threaded rod 80.

Referring back to FIG. 1, the present invention provides the electrical system 90 to power the motor 54 of the motor assembly 50. The electrical system 90 includes a switch 92, a power cord 94, a pair of detect switches 96, and a control circuit (not shown-internal to the base 20). One detect switch 96 is positioned on the support 60 and one on the support 70, both positioned so that they can be tripped by the slider 40. The detect switches 96 could also be located on the base 20, on the clamp 30, or even on the slider 40. The detect switches 96 can be mechanical (i.e. microswitches or buttons) or electrical (i.e. photosensors or Hall detectors) and act to switch the direction of the motor 54. That is, when the slider 40 reaches one end of the clamp 30 it trips the detect switch 96, which reverses the drive direction of the motor 54. To accommodate the detect switches 96, the control circuit is of simple design and may only need to comprise wires if the motor 54 itself provides an electronically actuated reverse control. As a result, the human-actuated switch 92 can be a simple push-button. On the other hand, if the switch 92 is chosen as having off, forward, and reverse settings, the control circuit can be as simple as a set of wires connecting the power cord 94, switch 92, and motor 54. The detect switches 96 can be eliminated. That is, the motor 54 is stopped and driven in either direction by the user selecting the position of the switch 92, affording precise control of the cutting device 10 and relying on the friction clutch 56 for safety. Another way to remove the need for the detect switches 96 is to provide the control circuit with a simple logic circuit coupled to a current meter that measures the current drawn by the motor 54. In addition, it may be generally desirable to provide the control circuit with a current limiting circuit to shut off the motor 54 when too much current is demanded, this acting to supplement or even replace the friction clutch 56. Essentially, the electrical system 90 acts to drive the motor 90 in either direction as determined by user actuation of the switch 92.

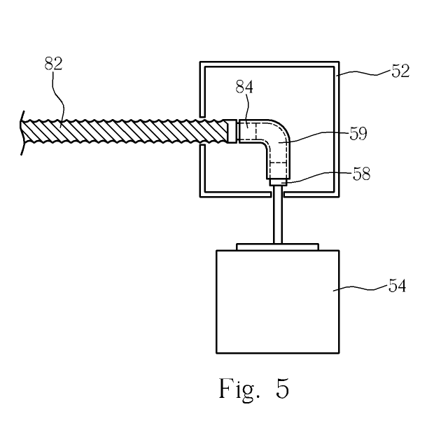

FIG. 5 shows another embodiment of the motor assembly. In this embodiment a flexible hollow tube 59 is provided to connect a narrowed unthreaded section 84 of the threaded rod 80 to a spindle 58 of the motor 54. The flexible hollow tube 59 can inherently act as a friction clutch in that the tube can be designed to slide against the unthreaded section 84 or the spindle 58 at a torque exceeding a safe limit.

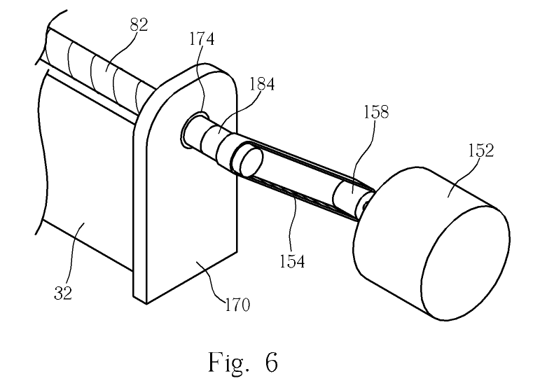

FIG. 6 shows another embodiment of the motor assembly. Here a motor 152 is disposed on the base 20 and connected to an unthreaded portion 184 of the threaded rod 80 by way of a spindle 158 and belt 154. The friction clutch can be implemented at the joint between the unthreaded portion 184 and the threaded portion of the threaded rod 80. Further provided are a support 170 having a hole 174 for accommodating the threaded rod 80 (rather than the slotted support 70). In this embodiment, the threaded rod 80 does not move up or down with the clamp body 32, although it could with simple modifications.

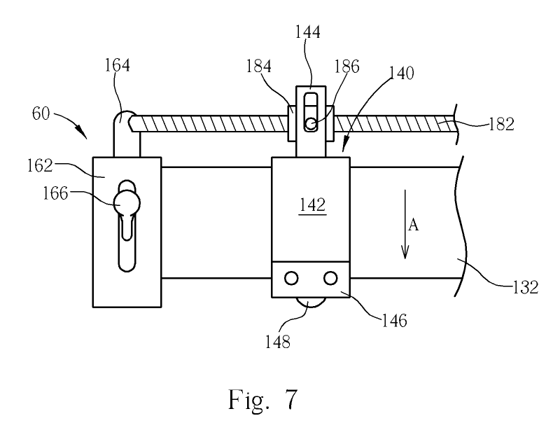

FIG. 7 illustrates another embodiment of the linear actuator and slider. A support 160 and a clamp body 132 are similar to the support 60 and clamp body 32 of FIG. 2, except that a post 164 for rotatably securing a threaded rod 182 is fixed to the top of a support body 162 (instead of the post 38 connected to the moveable clamp body 32). That is, the threaded rod 182 does not move in the A direction and opposite like the threaded rod 80. Rather, the threaded rod 182 is only permitted to rotate. The support 160 further includes a handle 166 connected to a clamp actuator (see FIG. 2) for moving the clamp body 132 in the A direction and opposite. To accommodate the non-translating threaded rod 182, a slider 140 having a body 142, panel 146, and cutting tool 148, also includes a slotted post 144 to connect with a pin 186 of a threaded collar 184, which rides on the threaded rod 182. When the threaded rod 182 is rotated, the collar 184 translates along it regardless of the position of the slider 140 in the A direction, as provided for by the slotted post 144 and the pin 186. A similar mechanism in which the positions of the pin 186 and slot of the post 144 are reversed is also acceptable. Additionally, the motor assembly used with this embodiment can be like those shown in FIGS. 4-6, with the second support being like support 170 of FIG. 6. Other aspects of operation are similar to the preceding embodiments.

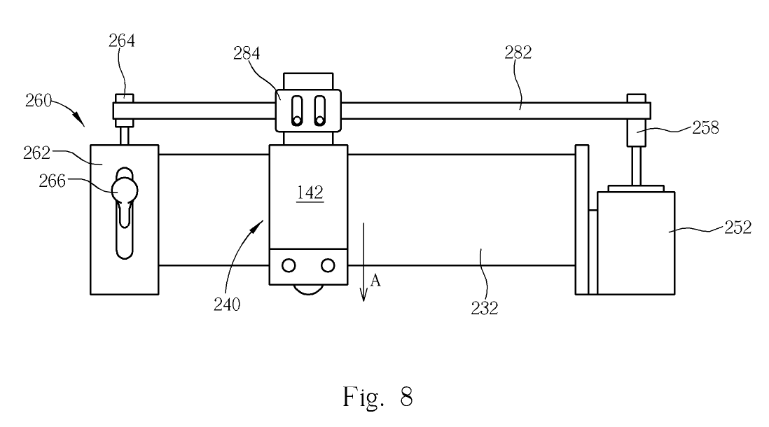

FIG. 8 illustrates an embodiment having a belt-type linear actuator rather than a threaded rod. This embodiment includes a support 260 having a body 262, a rotating belt spindle 264, and a handle 266. A clamp body 232 is moved in the A direction and opposite by the handle 266 and a clamp actuator (see FIG. 2). A motor 252 drives a belt 282 between a spindle 258 and the spindle 264. A slider 240, similar to the slider 140 rides the belt 282 via pins fitting into a slotted plate 284 fixed to the belt 282. In this embodiment, the belt 282 does not move in the A direction and opposite, only the slider 140 and clamp body 232 do. Other aspects of operation are similar to the preceding embodiments.

In contrast to the prior art, the present invention automatically drives a cutting tool by way of a motor and a linear actuator. The linear actuator can be a threaded rod or a belt. The transmission from the motor to the linear actuator can be geared, flexible, or belt-based. The automatic drive assembly provides convenience to the user, and the slider allows the cutting tool to be small and safe.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A flat media cutting device comprising:
a planar base having a normal vector in a first direction;
two supports fixed to the base;
a clamp extending in a second direction perpendicular to the first direction between the two supports, each end of the clamp connected to one support, wherein at least one support prevents movement of the clamp in the second direction and opposite and the supports allow movement of the clamp in the first direction and opposite;
a clamp actuator connected to one end of the clamp or the corresponding support for moving the clamp in the first direction and opposite, the clamp actuator comprising a handle;
a threaded rod parallel to the clamp, the threaded rod rotatably connected to the clamp at one end;
a slider mounted in a slidable manner on the clamp, the slider comprising slider body, a threaded surface connected to the slider body and meshing with the threaded rod, and a cutting tool;
a transmission connected to the other end of the threaded rod, the transmission allowing the threaded rod to move in the first direction and opposite with the clamp, wherein the transmission is a belt or a flexible connector; and
a motor connected to the transmission for driving the threaded rod;
wherein after the clamp actuator is actuated to cause the clamp to press media to the base, the motor drives the threaded rod so that the slider is driven along the clamp and the cutting tool cuts the media.

2. The flat media cutting device of claim 1 further comprising:
a switch connecting the motor to a power source, wherein the switch controls electrical power flow to the motor; and
two detect switches connected to the motor, each installed at one end of the range of movement of the slider along the clamp, wherein the slider triggering a detect switch reverses the direction of the motor.

3. The flat media cutting device of claim 1 further comprising a mechanical clutch connected between the motor and the threaded rod, the mechanical clutch limiting the torque that the motor provides to the linear actuator.
